(19) United States
(12) Patent Application Publication
(10) Pub. No.: US 2004/0199767 A1
(43) Pub. Date: Oct. 7, 2004

(54) Communication method for controlled data exchange between a client terminal and a host site network and protective server set therefor

(76) Inventor: Gabriel Gross, Paris (FR)

Correspondence Address: Dan C Hu, Trop Pruner & Hu, Suite 100, 8554 Katy Freeway, Houston, TX, 77024, US

(21) Appl. No.: 10/485,606

(22) PCT Filed: Feb. 13, 2003
(86) PCT No.: PCT/FR02/02564

(30) Foreign Application Priority Data
Aug. 2, 2001 (FR) 01/10413

(51) Int. Cl. H04L 9/00

(52) U.S. Cl. 713/168

(57) ABSTRACT

The invention concerns a communication method for controlled data exchange between a client terminal (1) and a host site network (2) wherein: the data are exchanged, between the client terminal (1) and the network, via a protective server (6); the terminal identifier is masked, with respect to the network, at the protective server (6); and at least part of the data are protected from being read by an unauthorised person, when said data are communicated between the protective server (6) and the client terminal (1). The control of the data exchanges is achieved by means of an inference confidence inference engine set up for the host sites (2). The invention also concerns a device for implementing said method.

The invention relates to a communication method for controlled data exchange between a client terminal and a host site network, as well as to a protective server set for implementing said method.

In this document, the term “terminal” designates a personal computer, a mobile telephone, or any other device suitable for communicating with a network of data servers.

In a particular application, the method according to the invention is designed to enable an Internet user to control the broadcasting on the Internet of the information concerning him.

On the one hand, an Internet user may, for example in order to benefit from customized services, be induced to transmit to a host site certain data on his identity, his income, his preferences in terms of leisure, shopping, etc, but may nevertheless not want this information to be used for purposes other than those for which he has revealed it.

On the other hand, certain sites send, to the terminals of the Internet users who log onto them, cookies in order to install them automatically on those terminals. These cookies are files, which once recorded in the memory of these terminals, enable the server of the site that sent them to receive information on the Internet user and his behavior. Internet users sometimes want to prevent the installation of cookies on their terminals and to prevent, without necessarily losing all possibility of benefiting from customized services, the information concerning them being collected and used without their knowledge.

Through document EP-A-1 017 205, a method is already known for anonymously supplying information on the Internet user, when he browses on the Internet. In this method of the prior art, the information is recorded in a memory, a pseudonym is generated for the Internet user, this pseudonym is linked to the information contained in the memory, in a register, and the register is transmitted, automatically or in response to the commands of the Internet user, to the sites consulted by the latter. These sites therefore have access to the information in question only in liaison with the pseudonym. Such a pseudonym is usually linked to an avatar, that is a virtual representation created by the Internet user for moving around in cyberspace.

However, such a method cannot in particular be used to prevent the Internet access provider (also known by those skilled in the art as the “ISP” for Internet Service Provider) , with which the Internet user has a subscription, from having knowledge of the identity of the sites consulted by the latter.

Also known are software programs which, once installed on the terminal of the Internet user, enable the latter to select the cookies he wishes to have recorded on his terminal.

However, such software programs offer no protection of the data transmitted on the network, from the terminal of the Internet user, irrespective of whether these data are collected by means of the cookies or the others.

There is also a requirement for methods and devices for protecting the privacy of Internet users which can be used where appropriate to offer customized services.

An aim of the invention is in particular to provide a method of communicating data between a client terminal and a host site network, enabling better protection of these data with respect to their use by unauthorized third parties and, in preference, enabling the offer of customized services.

This aim is achieved, according to the invention, by means of a communication method for controlled data exchange between a client terminal and a host site network, this method being characterized in that:

the data are exchanged, between the client terminal and the network, via a protective server,

the client terminal identifier is masked, with respect to the network, at the protective server,

at least part of the data is protected from being read by any person not authorized to read this part of the data, when said data are communicated between the protective server and the client terminal,

a preferences profile categorizing a client terminal user and approved by that user is compared with knowledge on at least one host site, and

the data exchange between the client terminal and this host site is controlled according to information arising from this comparison.

Specifically, according to this method:

on the one hand, between the client terminal (an Internet user terminal for example) and the protective server, the data exchanged are rendered, at least in part, if not totally, confidential by the protection of at least a part of the said data; thus when the user accesses the protective server by means of a network access provider, at least part of the data exchanged between the protective server and the client terminal is protected from being read by the service provider; and

on the other hand, the identifier of the client terminal (IP address for a terminal connected to the internet; IP being the acronym for “Internet Protocol”) is masked and the data transmitted between the client terminal and the rest of the network are subject to a control, according to what the user wants, of the information concerning him, to broadcast or not broadcast on the network.

Thus, certain of the data which concern the user may, if the latter wishes, not be known, either by third parties operating the sites visited by him, or by third parties that send cookies to the Internet user's terminal without this user having chosen to log on to a site of these third parties (for example advertising organizations), or even by his access provider.

In preferred embodiments, the method according to the invention comprises one and/or other of the following features:

addresses of host sites to which data is sent from the client terminal are masked from the access provider; in the context of an Internet connection, these addresses are URL addresses (acronym for “Uniform Resource Locator”);

the protective server supplies on request, instead of the access provider, an address of a host site identified by a name, in correspondence with this name, by means of a domain name system; thus in the context of an Internet connection, this system of domain names is called DNS (acronym for “Domain Naming System”);

a part, comprising information on the identity of the client terminal, of a request formulated from the client terminal intended for a host site, is modified, or even eliminated, before traveling to the host site for which the request is intended; thus in the context of an Internet connection, it is a part of what is known by those skilled in the art as the “header” of the request that is the subject of this modification;

it comprises a filtering of cookies originating from the network by the protective server and a storing, at the protective server, of at least a part of these cookies; certain cookies are eliminated whereas others are recorded at the protective server; no cookie is stored on the client terminal, but the user may nevertheless benefit from the advantages provided by certain of these cookies, such as the offer of services customized according to the information profile attached directly to his identity or to the avatar or avatars which represent him;

an electronic mail server supplies at least one disposable electronic mail address;

it comprises a monitoring of the use of the disposable address by a third party to whom that electronic mail address has been sent;

a plurality of electronic mail accounts is allocated to a user, with a unique portal, independent of the client terminal and personal for managing these accounts;

a trust status is associated with a host site, according to knowledge, stored in a knowledge base, on at least the policy of protection of the personal data by a third party operating this host site; this policy is for example defined on the one hand by a P3P form (“Platform for Privacy Preference Project”) categorizing a site, and on the other hand, by tests on the use of the information by this site and/or by general knowledge (reputation for example) of the company operating this site;

a form for the input of information on the user, supplied by a host site and intended for recording the information input, by this host site, is completed automatically by the protective server according to the trust status, before being submitted for the user's approval;

the approval by the user is performed automatically according to a protection profile that he has predefined;

the user of the client terminal is represented, with respect to the network, by at least one avatar; thus the user can broadcast categorizing data, for example on his preferences, without them necessarily being attached to his actual identity;

an information profile comprising the preferences profile and associated with the actual identity of the user or with each avatar is stored in a knowledge base, this profile being determined, at least in part, by the behavior of the user when he communicates with the network using this avatar; thus, the preferences associated with the user's avatar may be taken into account in this profile; the information profile comprises the categorizing data on the user, associated with this avatar;

the information profile is modified by the user via a configuration server; this enables the user to modify the data concerning him recorded in this information profile, for example, to refine this profile in order to improve the customization of the services that may be offered to him or to remove from this profile information that he does not want to have broadcast;

an authorization of use, by a third party operating a host site, of the information attached to the user's actual identity or to the avatar by which the user accesses this host site is governed by the user, by the selection and activation of a predefined protection profile; for example, the user may thus choose a “paranoid” profile by which, for example, he may automatically and systematically refuse the transmission of any information concerning him, a “normal” profile by which he can accept that certain information is communicated only if the site to which it is sent benefits from a degree of trust, or a “flexible” profile by which he can accept that any information attached to the avatar that he uses is transmitted to the site or sites to which he connects;

the protection profile is compared with the trust status to define an automatic processing of the data exchanged between this host site and the client terminal, when the user wants to set up a communication with a host site and prior to that communication, and/or when a host site wants to enter into communication with the client terminal (for example, an advertising organization); and

the automatic processing of the data exchanged between the host site and the client terminal comprises the filtering of cookies originating from the network and the storing, at the protective server, of at least part of the filtered cookies; thus, for example, if the user chooses a “paranoid” profile, any cookie originating from a site with a weak trust status is refused, whereas with a “normal” profile, he may automatically accept the cookies originating from this host site which are destroyed at the end of a connection session with the latter, or a “flexible” profile by which he can accept the storage of any cookie originating from this site.

According to another aspect, the invention proposes a protective server set to form the interface between a client terminal and a network of host sites and enable a user of the client terminal to control the broadcasting of information concerning him, on the network, this protective server set comprising:

means, at a protective server, of masking the identifier of the client terminal, with respect to the network,

means of protecting at least part of the data from being read by any person not authorized to read this part of the data, when these data are communicated between the protective server and the client terminal,

means of comparison to compare, with knowledge on at least one host site, a preferences profile categorizing the user and approved by the latter, and

means of controlling, according to information generated by the means of comparison, the exchange of data between the client terminal and this host site.

In preferred embodiments, the method according to the invention comprises one and/or other of the following features:

it comprises means of creating at least one avatar by which to represent the user with respect to the network;

it comprises means of managing an information profile based on personal data and on the communications it sets up with the network;

it comprises means of protecting at least a part of the data exchanged between the protective server and the client terminal from being read by a network access provider;

it comprises means of masking, from the access provider, addresses of host sites to which data are sent from the client terminal;

the protective server supplies on request, instead of the access provider, an address of a host site identified by a name, in correspondence with this name, by means of a domain name system;

it comprises means of eliminating a part, comprising information on the identity of the client terminal, of a connection request, formulated from the client terminal intended for a host site, before that request travels to the host site for which it is intended;

it comprises a knowledge base, associated with the user's actual identify or with an avatar of the user, wherein is recorded information on the behavior of the user when he communicates with the network by using respectively his actual identity or this avatar;

it comprises a database intended to store at least one manifesto of the policy of protecting the personal data of a host site, and means of comparing each manifesto with the information recorded in the knowledge base in association with an avatar of the user or his actual identity; such a manifesto is for example a P3P form; the means of comparison advantageously consist of a trust status inference engine; an inference engine enables the production of new proposals based on proposals held to be known, by implementing inference rules; in the protective server set, the proposals held to be known comprise the manifesto of the protection policy of a host site, the new proposals comprise the trust status and the inference rules are defined based on the information associated with the user's avatar;

it comprises means of filtering cookies originating from the network and means of storing, after approval by the user, at least a part of the filtered cookies;

it comprises a plurality of protective servers organized into a network of proxy servers to allow increased proximity between the client terminal and at least one of these protective servers;

it comprises a central server to direct the user to the protective server closest to the client terminal; and

it comprises a server dedicated to the creation of avatars and to the storage of cookies, and comprising a knowledge base, associated with the actual identity of the user or with an avatar, wherein is recorded information on the user's behavior when he communicates with the network using his actual identity or this avatar.

According to yet another aspect, the invention proposes a computer program loadable into a memory, associated with a processor, and comprising portions of codes for the implementation of a method as previously specified, when the said program is executed.

According to yet another aspect, the invention proposes a computer program loadable into a memory, associated with a processor, and comprising portions of codes to manage the communication between the client terminal and the protective server set as previously specified, when the said program is executed.

According to yet another aspect, the invention proposes a data medium on which is recorded a computer program as previously specified.

According to yet another aspect, the invention proposes a method of downloading a computer program as previously specified.

Other aspects, aims and advantages of the invention will emerge on reading the following detailed description of one of its embodiments. The invention will also be better understood with the aid of the references to the drawings in which:

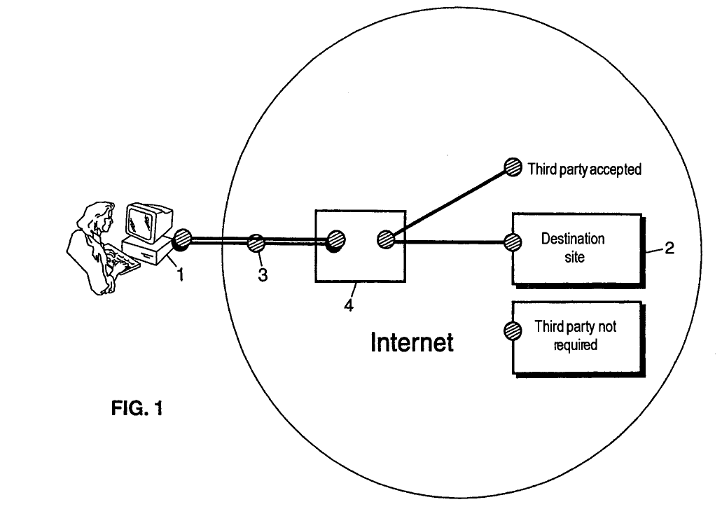

FIG. 1 represents schematically the structure of the communication between a client terminal and a host site network, in an exemplary implementation of the method according to the present invention;

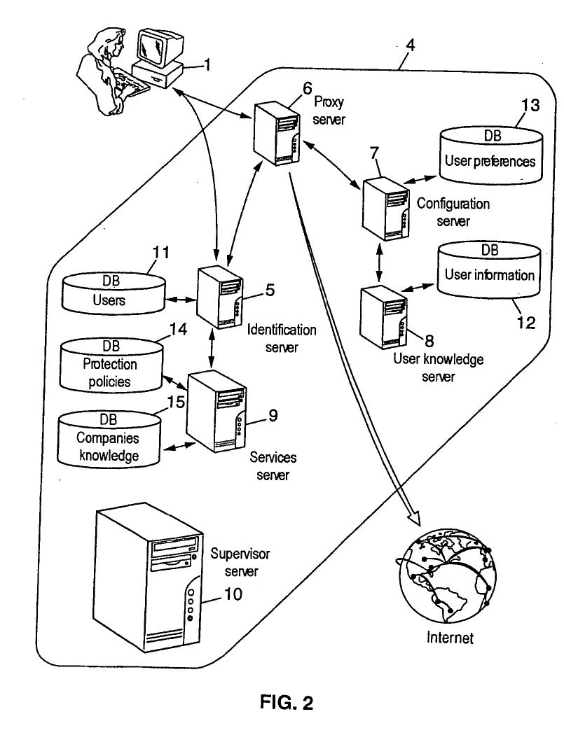

FIG. 2 represents schematically the architecture of a server set for the implementation of the exemplary method represented in FIG. 1; and

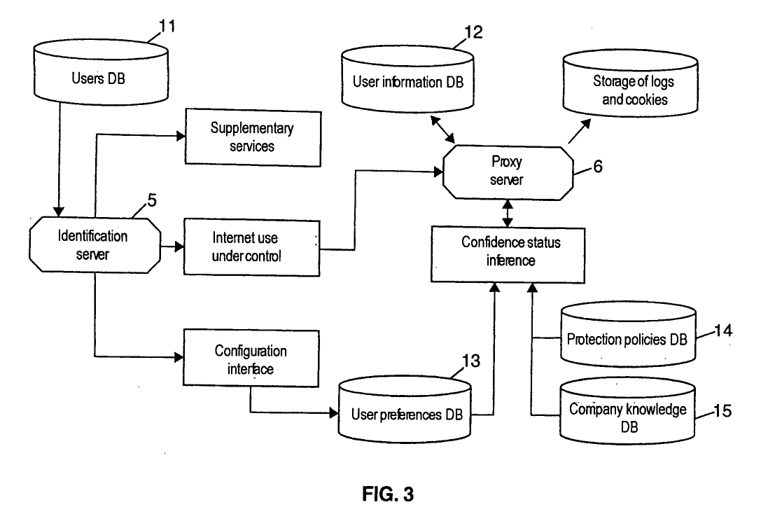

FIG. 3 represents schematically the architecture of the protection functions of the server set the architecture of which is represented in FIG. 2.

The invention is described below in the context of its implementation to render confidential the communication between a client terminal, consisting of a personal computer 1, and a set of host sites 2 such as Internet sites.

As represented in FIG. 1, the personal computer 1 is connected to the Internet via an access provider 3 and a protective server set 4.

The protective server set 4 offers numerous functions.

As an illustration, FIG. 1 represents the case in which the protective server set 4 enables the Internet user of the personal computer 1 to control and accept or reject the intervention of third parties during his communication with a destination site 2. Specifically, when a user consults a page on this destination site 2, it may happen that this page contains insertions emanating from third parties (advertising for example) and that, in addition, this third party sends a cookie to the Internet user's computer. By means of the protective server set 4 according to the invention, the Internet user may choose to accept or reject the cookie sent by this third party.

The general architecture of a protective server set 4 as represented in FIG. 1 is illustrated by FIG. 2.

This protective server set 4 comprises mainly:

an Identification server 5,

a network of Proxy servers 6, each Proxy server 6 being associated with a Configuration server, in turn associated with a User Knowledge server 8,

a Services server 9 and

a Supervisor server 10.

In the rest of this document, for the sake of simplification, the protective server set 4 is described with a single Proxy server 6 with which is associated a single Configuration server 7, in turn associated with a single User Knowledge server 8, although these various servers are duplicated in a network.

As represented in this FIG. 2, the Internet user accesses the Internet network from his personal computer 1. In order to use the services of the protective server set 4, the Internet user employs access, configuration and reporting tools.

These access, configuration and reporting tools are programs of computer 1 recorded in the computer's memory from a medium such as a CD ROM or after downloading from an Internet site which distributes such programs.

These access, configuration and reporting tools are suitable for enabling the Internet user:

to be identified at the protective server set 4,

to receive in return an “access token” for a session,

to create avatars or modify an existing avatar,

to select an avatar for connecting to the Internet network,

to select a predefined information profile, where appropriate to modify this predefined information profile in order to customize it and/or to create an information profile completely,

to attach to an avatar the selected, modified or created predefined information profile,

to modify a preference profile attached to an avatar,

to obtain a browsing report,

to activate a service of protection of his privacy by the protective server set 4 on the basis of the selected information profile and

to access other services that are accessible on the protective server set 4.

The Internet user connects to the protective server set 4 at the Identification server 5. The identification function of the Identification server is implemented by means of the functions relating to the personal identification certificate of the Internet user's Internet browser. The Identification server compares the Internet user's identity with data on the users that have access to the protective server set 4, stored in a Users database 11. After identification, the authorized Internet users receive an “access token” for a session.

The Internet user having received an “access token” for a session accesses the Proxy server 6. Advantageously and essentially for reasons of performance in communication rates and bandwidths, the Proxy server 6 is the Proxy server located as close as possible to the Internet user.

The Proxy server 6 implements the interface between the Internet user, the other servers of the protective server set 4 and the Internet network. Its main functions are to:

filter and select the cookies originating from the network;

make a comparison between the expression of a privacy protection policy, of a site 2 and the information profile attached to the avatar used by the Internet user to access this site 2,

divert and store the cookies accepted by the Internet user,

modify the header of connection requests,

delete the Internet user's identification address (IP address) from the data sent to the destination sites 2, as well as the address of these destination sites 2, from the data traveling via the access provider,

automatically complete forms according to the trust status associated with the site 2 that has sent this form,

carry out, according to the DNS table, the name/address conversion of the sites 2 targeted by the Internet user,

analyze the content of the web pages consulted and remove from those pages the elements not required by the Internet user, and

establish the history of the connection sessions and the preferences of the Internet user.

The filtering and selection of the cookies are carried out according to data stored in a User Information database 12 which comprises amongst other things the Internet user's wishes as regards the processing of the cookies.

The cookies considered acceptable by the Internet user are stored in a memory. This memory is accessible to the Internet user and to the server of the site 2 which has sent it, but is not located on the computer 1 of the Internet user.

The header of the connection requests, whether this connection is established according to the http protocol or according to another protocol, is modified, before traveling to the site 2, according to criteria and rules of protection and respect of privacy defined by ethnics committees.

The history of the sessions and the preferences of the Internet user are, according to his information profile, either destroyed or transferred to the User Knowledge server 8 associated with the Proxy server 6.

The Proxy server 6 is programmed using programs that are free and well known to those skilled in the art (Squid®, Apache®, etc).

The Configuration server 5 is used to:

create, select or modify an avatar and/or an information profile,

select, create and/or configure preferences profiles,

consult the cookies, download them or destroy them, and

access services such as “Help”, “FAQ”, electronic mail, etc, as well as the browsing report.

The Internet user can create several avatars. To each avatar is attached one or more electronic addresses, a memory for storing cookies and connection files, an information profile, a preferences profile, etc. The information and preferences profiles may differ from one avatar to another.

An information profile comprises identifying information and categorizing information concerning the Internet user. The identifying information is, for example, his civil status, his address, etc. The categorizing information is, for example, his age, his interests, etc. The identifying information may be real or virtual. It is recorded for each avatar. The method according to the invention enables its divulgation to be controlled. The Internet user chooses to confer a greater or lesser degree of anonymity on a given avatar. With certain avatars, he may associate a pseudonym, whereas he may reveal his identity with others (for example for on-line purchases). He may also, for example, indicate different interests for different avatars to obtain services that are customized and specialized according to his interests.

The management of the information profiles, in relation to the avatars of each Internet user, is carried out at the User Knowledge server 8, by means of the information stored in the User Information database 10. The User Knowledge server 8 and the User Information database 10 are highly secure.

This information profile management is carried out by the Internet user, by means of one or more Web pages edited and managed by the Configuration server 7 in relation with the User Knowledge server 8. Each Web page interfaces the communication between the Internet user and this Configuration server 7.

To these information profiles are added one or more preferences profiles. The Internet usesr's preferences profiles are generated from the information supplied directly by the Internet user or from the analysis of his behavior (Web pages consulted, connection times, etc). A distinct preferences profile can be associated with each avatar. The user's preferences profiles are stored in a User Preferences database 13 directly accessible via the Configuration server 7.

The browsing report comprises:

the history of the Internet user's browsing sessions,

the list of cookies received during these browsing sessions,

the status of the current connection session, which in particular informs the Internet user regarding the profiles attached to the avatar that he is using and the site or sites 2 to which he is connected,

the recent actions (for example: “disabling of a cookie sent by ‘The advertising strip server X’ during consultation of the ‘Y insurance’ site”), and

explanations of them (for example: “The host site wanted to access your browser's history to use the data to define a profile and customize or adapt its services to that profile”).

The status of the current connection session evolves with time and is recorded as it evolves.

The browsing report is managed by the User Knowledge server 8 via an interface generated by the Configuration server 7. Access to this interface is via the Internet user's browser, by means of the “access token”. This access is initiated based on a specific application such as an icon or a command line (Systray® for a computer running with Windows®, Menu Bar Icon® on a Mac®, an icon on a Linux® box).

The Proxy server 6 can also be used to access the Services server 9.

This Services server 9 manages, amongst other things, information on the host sites and their policy of protecting the privacy of the Internet users. This information is used in the implementation of the protection functions of the protective server set 4. The set of protection functions is illustrated by FIG. 3.

The protection functions of the protective server set 4 are linked to the policies of use of the personal data by sites 2 of the Internet network, to knowledge concerning threats, with respect to the privacy of the Internet users, as represented by certain sites 2 (third party cookies, advertising, etc) and to electronic mail.

More precisely, the policies of use of the personal data by sites 2 are listed and stored in a Protection Policies database 14. These policies correspond for example to the P3P policies of the host sites 2, advantageously supplemented by various information. This various information on the host sites 2 is for example collected by the protective server set 4 and stored in a Companies Knowledge database 15. It concerns for example the use of the electronic addresses made by the sites 2, the reputation of these sites 2 and the relations of these sites 2 with third party sites. The durability of these policies and of the information to which they correspond are regularly checked (for example with a check of the checksum type).

Based on the Companies Knowledge database 15, the Services server:

supplies indications to the Proxy servers 6 which, supplemented by the information and preferences profiles, define the automatic processing to be applied to the data streams exchanged between the Internet user and the network,

establishes lists of domains, IP addresses and other sources of information likely to be used by advertising servers and other well known servers to send tracking cookies to the personal computers, and

controls the evolution of these lists.

The information thus listed, in the Protection Policies 14 and Companies Knowledge 15 databases, is compared with the preferences profile selected in the User Preferences database 13, by the Internet user to infer automatically a trust status on each site visited by the Internet user (see FIG. 3).

The Services server 9 also manages electronic mail. The Services server 9:

supplies electronic addresses on request to the Internet user using the protective server set 4,

substitutes disposable addresses for real addresses, for example after validation of a form proposed to the Internet user,

monitors the use of the disposable addresses by the sites 2 for which they are intended, analyzes this monitoring and records it in a log,

filters the incoming electronic mail according to its source and the user's preferences,

where necessary carries out an anti-virus check on the incoming electronic mail and

dispatches the electronic mail accepted after the above filtering and check where necessary.

All the servers of the protective server set are under the control of the Supervisor server 10.

This Supervisor server 10:

manages the DNS table and directs the Internet user, via a central server (not shown), to the Proxy server 6 closest to him,

provides an interface for auditors and traceability functions at the request of these auditors, and

supervises, in quasi real time, the activity of each server of the protective server set 4, with recording of the events in a log and checking of the performance of the protective server set 4.

In addition to the use of the Internet network in controlling the protection of the data that is personal to him and the configuration of tools for managing this control, the protective server set 4 allows an authorized Internet user to access other Services such as:

the programming of alerts according to events in discussion forums,

secure interaction with bank accounts, etc.

The environment relating to the functions of communication with the protective server 4 and the Internet network is programmed in the Java® or PHP® (Hypertext Processor) language.

1. A communication method for controlled data exchange between a client terminal and a host site network, comprising:
exchanging the data between the client terminal and the network, via a protective server,
masking a client terminal identifier, with respect to the network, at the protective server,
protecting at least part of the data from being read by any person not authorized to read the part of the data, when said data is communicated between the protective server and the client terminal,
comparing a preferences profile categorizing a client terminal user and approved by the client terminal user with knowledge on at least one host site, and
controlling the data exchange between the client terminal and the host site according to information arising from the comparison.

2. The method as claimed in claim 1, further comprising the user accessing the protective server using a network access provider for which at least part of the data exchanged between the protective server and the client terminal is protected from being read.

3. The method as claimed in claim 2, further comprising masking addresses of host sites to which data is sent from the client terminal from the access providers.

4. The method as claimed in claim 2, further comprising the protective server supplying on request, instead of the access provider, an address of a host site identified by a name, in correspondence with this name, by means of a domain name system.

5. The method as claimed in claim 1, further comprising modifying a part, comprising information on the identity of the client terminal, of a request formulated from the client terminal intended for a host site before traveling to the host site for which the request is intended.

6. The method as claimed in claim 1, further comprising filtering cookies originating from the network by the protective server and storing, at the protective server, at least a part of the cookies.

7. The method as claimed in claim 1, further comprising an electronic mail server supplying at least one disposable electronic mail address.

8. The method as claimed in claim 7, further comprising monitoring the use of the disposable address by a third party to whom that electronic mail address has been sent.

9. The method as claimed in claim 1, further comprising allocating a plurality of electronic mail accounts to a user, with a unique portal, independent of the client terminal and personal for managing these accounts.

10. The method as claimed in claim 1, further comprising associating a trust status with a host sites, according to knowledge, stored in a knowledge base, on at least the policy of protection of the personal data by a third party operating this host site.

11. The method as claimed in claim 10, further comprising automatically implementing a form for the input of information on the user, supplied by a host site and intended for recording the information input, by the host site, by the protective server according to the trust status, before being submitted for the user's approval.

12. The method as claimed in claim 11, automatically performing the approval by the user according to a protection profile that the user has predefined.

13. The method as claimed in claim 1, further comprising representing the user of the client terminal, with respect to the network, by at least one avatar.

14. The method as claimed in claim 13, further comprising storing an information profile comprising the preferences profile and associated with the actual identity of the user or with each avatar in a knowledge base, the information profile being determined, at least in part, by the behavior of the user when the user communicates with the network using the avatar.

15. The method as claimed in claim 14, further comprising modifying the information profile by the user via a configuration server.

16. The method as claimed in claim 13, characterized in that an authorization of use, by a third party operating a host site, of the information attached to the user's actual identity or to the avatar by which the user accesses this host site is governed by the user, by the selection and activation of a predefined protection profile.

17. The method as claimed in claim 16, further comprising:
associating a trust status with a host site, according to knowledge, stored in a knowledge base, on at least the policy of protection of the personal data by a third party operating this host site, and
comparing the protection profile with the trust status to define an automatic processing of the data exchanged between this host site and the client terminal, when the user wants to set up a communication with a host site and prior to that communication, and when a host site wants to enter into communication with the client terminal.

18. The method as claimed in claim 17, further comprising:
filtering cookies originating from the network by the protective server and a storing, at the protective server, at least a part of these cookies,
wherein the automatic processing of the data exchanged between the host site and the client terminal comprises the filtering of cookies originating from the network and the storing, at the protective server, of at least part of the filtered cookies.

19. A protective server set to form the interface between a client terminal and a network of host sites and enable a user of the client terminal to control the broadcasting of information concerning the user, on the network, the protective server set comprising:
means, at a protective server, for masking the identifier of the client terminal, with respect to the network,
means for protecting at least part of the data from being read by any person not authorized to read this part of the data, when the data is communicated between the protective server and the client terminal,
comparison means for comparing, with knowledge on at least one host site, a preferences profile categorizing the user and approved by the latter, and
means for controlling, according to information generated by the comparison means, the exchange of data between the client terminal and this host site.

20. The protective server set as claimed in claim 19, further comprising means for creating at least one avatar by which to represent the user with respect to the network.

21. The protective server set as claimed in claim 19, further comprising means for managing an information profile based on personal data and on the communications it sets up with the network.

22. The protective server set as claimed in claim 19, further comprising means for protecting at least a part of the data exchanged between the protective server and the client terminal from being read by a network access provider.

23. The protective server set as claimed in claim 22, further comprising means for masking, from the access provider, addresses of host sites to which data is sent from the client terminal.

24. The protective server set as claimed in claim 22, wherein the protective server supplies on request, instead of the access provider, an address of a host site, identified by a name, in correspondence with this name, by means of a domain name system.

25. The protective server set as claimed in claim 19, further comprising means for eliminating a part, comprising information on the identity of the client terminal, of a connection request, formulated from the client terminal intended for a host site, before that request travels to the host site for which it is intended.

26. The protective server set as claimed in claim 20, further comprising a knowledge base, associated with the user's actual identity or with an avatar of the user, wherein is recorded information on the behavior of the user when the user communicates with the network by using respectively the user's actual identity or the avatar.

27. The protective server set as claimed in claim 26, further comprising:
a database intended to store at least one manifesto of the policy of protecting the personal data of a host site, and
means for comparing each manifesto with the information recorded in the knowledge base in association with an avatar of the user or the user's actual identity.

28. The protective server set as claimed in claim 19, further comprising means for filtering cookies originating from the network and means for storing, after approval by the user, at least a part of the filtered cookies.

29. The protective server set as claimed in claim 19, further comprising a plurality of protective servers organized into a network of proxy servers to allow increased proximity between the client terminal and at least one of these protective servers.

30. The protective server set as claimed in claim 29, further comprising a central server to direct the user to the protective server closest to the client terminal.

31. The protective server set as claimed in claim 19, further comprising a server dedicated to the creation of avatars and to the storage of cookies, and a knowledge base, associated with the actual identity of the user or with an avatar, wherein is recorded information on the user's behavior when the user communicates with the network using respectively the user's actual identity or the avatar.

32. A computer program loadable into a memory, associated with a processor, and comprising portions of codes for the implementation of a method as claimed in claim 1, when the said program is executed.

33. A computer program loadable into a memory, associated with a processor, and comprising portions of codes to manage the communication between the client terminal and the protective server set as claimed in claim 19, when the said program is executed.

34. A data medium on which is recorded a computer program as claimed in claim 32.

35. A method of downloading a computer program as claimed in claim 32.
